(19) United States
(12) Patent Application Publication
(10) Pub. No.: US 2014/0098170 A1
(43) Pub. Date: Apr. 10, 2014

(54) SYSTEMS AND METHODS FOR CREATING MULTI-DIMENSIONAL IMAGES ON DEMAND FOR THE CREATION OF CUSTOMIZED PRODUCTS

(71) Applicants: William M Karszes, Norcross, GA (US); Jerry C. Nims, Atlanta, GA (US)

(72) Inventors: William M Karszes, Norcross, GA (US); Jerry C. Nims, Atlanta, GA (US)

(21) Appl. No.: 13/647,766

(22) Filed: Oct. 9, 2012

(51) Int. Cl. B41J 2/00

(52) U.S. Cl. 347/110

(57) ABSTRACT

A case system for an electronic device includes a case body, the case body shaped to hold an electronic device. The case system further includes a multidimensional image located on the case body. The case body includes a recess on an inner surface of the case body, the recess having a first thickness, the multidimensional image sized to fit in the recess, the multidimensional image having second thickness, the second thickness approximately equal to the first thickness, such that the multidimensional image in conjunction with the case body forms an approximately flat surface. The case body includes a lenticular lens on the case body on a surface opposite to the inner surface of the case body where the recess is located.

### BACKGROUND

The advent of wireless electronic devices such as cell phones, think pads, i-pads, etc. has created a demand for cases to protect the devices while people are using them in public or during travel. As these devices have become socially acceptable the desire to decorate or “accessorize” the case has increased. Numerous 2D methods exist to accessorize the electronic devices. Ways to customize such devices on an on-demand basis as well as the ability to provide three dimensional images is desirable.

### SUMMARY

This patent enumerates designs for mobile electronic devices and methods to manufacture said decorative parts. The use of micro-optical-arrays (also known as lenticular arrays) to produce auto-stereogram is known in the industry. These same inventors in the 1980's had developed and patented an analog 3D camera and new printers that delivered photographic 3D images. These arrays can also produce visual effects such as moving images (morphs, zooms) or flipping images and can be combined into multiple visual effects. The uniqueness of our processes is to combine this known technology with new designs to produce an innovative product. A systematic approach was undertaken to develop the needed technology to create products on demand from digital photos.

Three-dimensional, multi-media imagery is well documented. However, only professional graphic artist have mastered this medium. The system presented has moved this image presentation system forward towards the customer. We have developed a system where the end user utilizes their digital images and the customized features to create multi-dimensional images on demand for different new products. One such product is decorative covers for electronic devices.

Decorative accessories for electronic devices such as cell phones and i-pads have become a means of protecting the device, but also a means of personalizing the device. In order to further the stylization, multi-dimensional images maybe used to further enhance the fashion statement of these devices. These images can include but are not limited to flips, zoom, morphs and three dimensional images. The images may be incorporated in one of several means to the device. This patent shows several means of incorporating the images into a case or attaching the image directly to the device. The system developed can create images at an offsite manufacturing facility or create on demand images at an offsite facility. The same system can be modified to create an in-store system to create a useful decorative product.

Other products such as report covers, personal consumer pictures, greeting cards, advertising handouts and business cards can also be developed. This list represents only a partial list of products that is only limited by the imagination of the individual running the system.

The system was divided into four parts; (1) obtaining of images, (2) printing of images; and the (3) material that ties the image to the print to create the effect, and (4) product tools.

### BRIEF DESCRIPTION OF THE DRAWINGS

Illustrative embodiments are described in detail below with reference to the attached drawing figures, which are incorporated by reference herein and wherein:

FIG. 1 is shows one embodiment of a method of image creation;

FIGS. 2a and 2b are a diagram of one embodiment of a three level image;

FIG. 3 is a flow chart for one embodiment an in-store system of image creation;

FIG. 4 is a flow chart for another embodiment an in-store system of image creation;

FIGS. 5a-c show an embodiment of case and image system;

FIG. 6a shows another embodiment of case and image system;

FIG. 6b shows a cutaway view of the case of FIG. 6a;

FIGS. 7a-b show another embodiment of case and image system;

FIG. 8 shows another embodiment of case and image system;

FIG. 9 shows another embodiment of case and image system;

FIGS. 10a-b shows another embodiment of case and image system.

### DETAILED DESCRIPTION OF THE DRAWINGS

Systems and methods creating multi-dimensional images for use with portable electronic devices are disclosed herein. In some embodiments these images are affixed directly to the electronic device. In other embodiments these images are inserted in or otherwise combined with a case for the electronic device.

In one embodiment the system includes four main components:
1. Image: The customer is responsible to provide the image, unless a stock image template is chosen by the customer.
2. A printing system which would be a digital press at a manufacturing site or an upper end PC at a retail outlet. Within the printing system we include software and computer to complete the image and send to the printer.
3. Material (Micro-Optical-Material)
4. Manufacturing tools which could be an injection molding machine and/or laminator at a manufacturing site. A retail outlet would need a laminator and small punch die.

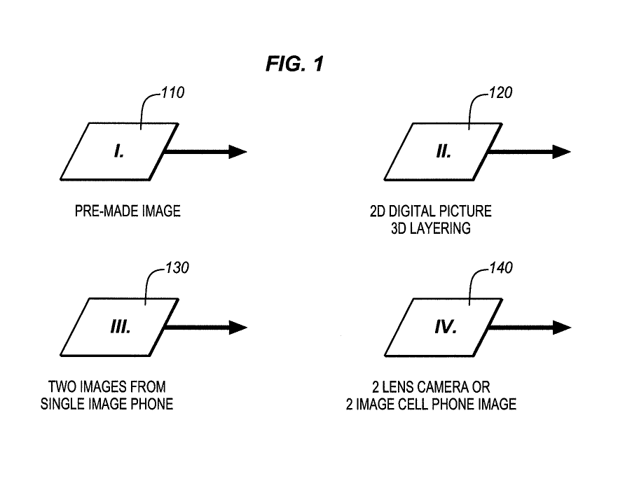

In some configurations the customer may control the image. The customer determines what images and themes will be used as well as inputting the images necessary for each input technique. There are at least five input techniques for a customized on demand skin (four of which are show in FIG. 1).

Print Ready Images 110 may be provided. These images are fully developed stock images that can be personalized with names, dates, etc. Single Digital Images provided by customer may be provided. An image from camera or cell phone is combined with a catalog border. (Borders for different holidays, themes and colors) Customized information is added such as name date, etc. This results in the 3D layering of a 2D picture 120.

Two images from one camera (or phone) 130 may be utilized. Using a binocular technique the customer would click the image using the right eye to focus and then take a second picture by focusing on the same image using the left eye. The two images will be displaced by the width of the eyes on the customers head. This is not a preferred method as motion cannot be captured and some out of focus can occur.

Dual images from multi-lens camera 140 or cell phone may be used. Two or more images are taken simultaneously with a multi-lens camera or phone. The images are sent to the software and the images are combined into a 3D image. Annotations and salutations can then be added to further personalize the image.

Additionally, a specific application (“app”) containing algorithms to create a 3D image (without glasses) on a smart phone used as a camera or any other similar device may be utilized. This algorithm is an extension of #2 & #3 which simplifies the sending of images to a processing location

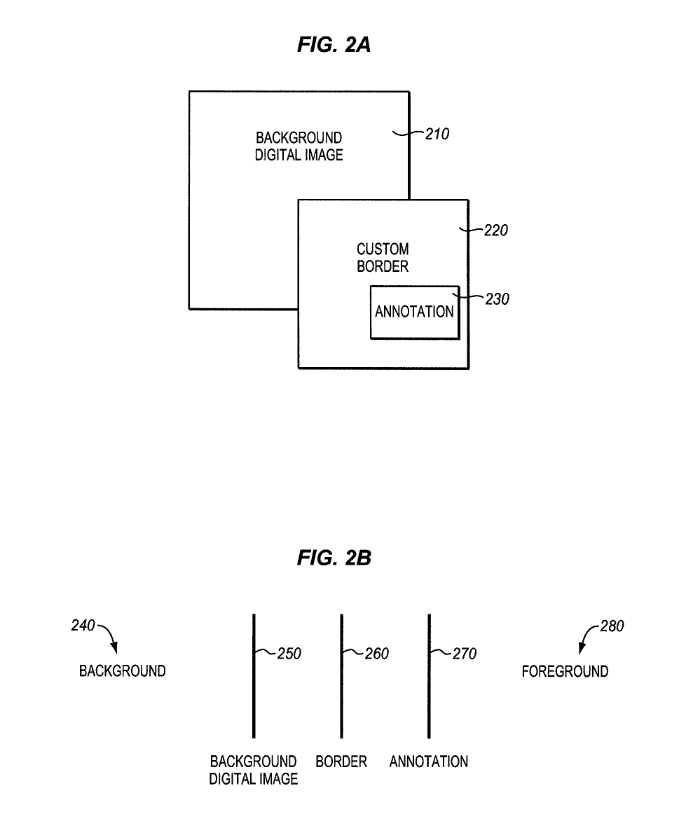

The images may be inputted via the internet to a central manufacturing location or may be inputted at a shop such as a photo center at Wal-Mart or Staples. Once the images are obtained they are inputted into the software and personalization is added by the technician. A simple three layer system for multi-dimension is shown in FIG. 2a-b. FIG. 2a shows the various parts of an exemplary multidimensional image. In this example, the image includes a digital image 210, a custom border 220, and an annotation 230. As shown in FIG. 2b, the image may be presented at differently perceived visual levels. In this example, working from background 240 to foreground 280, the image 250 may be presented at a greatest visual distance, then frame 260, and then annotation 270 provided. Various other configurations of images may be utilized not limited to a frame, image, and annotation. Multiple images may be utilized, etc. The finished image is interphased by the program and prepared for printing and adjusted to the material lens system. The image is then printed on a special printer which prints directly onto the back of the material in a mirror imaged technique. Then a simple white backing is applied and the piece is die cut.

The image could also be printed on a standard high quality commercial printer produced by Epson, Cannon or HP, etc. (Typically we use a flat bed printer with 9400 DPI (dots per inch). The Cannon Pro 7500 is an example.) The image is then uploaded into an automatic laminator controlled by a robot that aligns the print to lens material optically and then bonds them with a UV (ultraviolet) adhesive. The piece is die cut and finished.

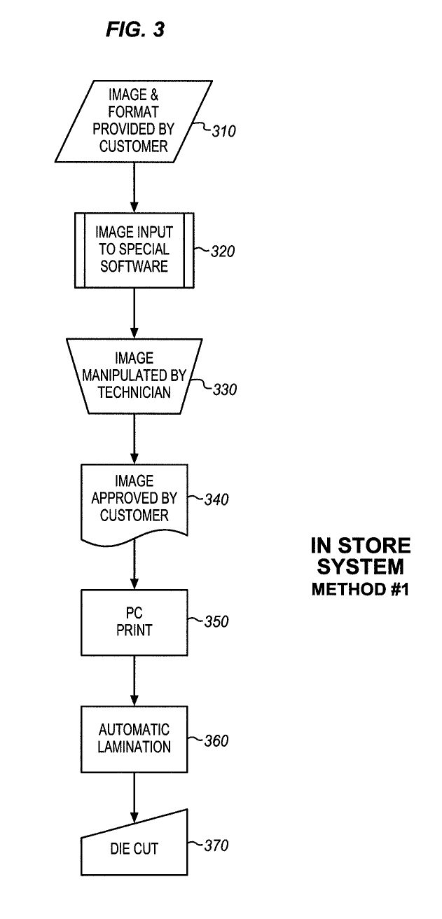

FIG. 3 shows a first in-store method for creating customized images. First, an image and format are provided by a customer in step 310. As discussed above, alternatively, stock images may be used as well. In step 320, the image is input to image processing software that will prepare the image for multi-dimensional rendering. In step 330 the image is manipulated by a technician to align the multi-dimensional aspects of the new image. Alternatively, this may be performed by the customer. A special program may be provided or the system may run through a web interface or other interface. In step 340 the image is approved by the customer. The special software will provide a rendering of the multidimensional view that is provided. In step 350 the image is printed and in step 360 the image is laminated. In this method, the lenticular structure of the case will be known, and the placement of the image behind that lenticular structure will provide for the multidimensional presentation of the image. In step 370 the image is die cut for application.

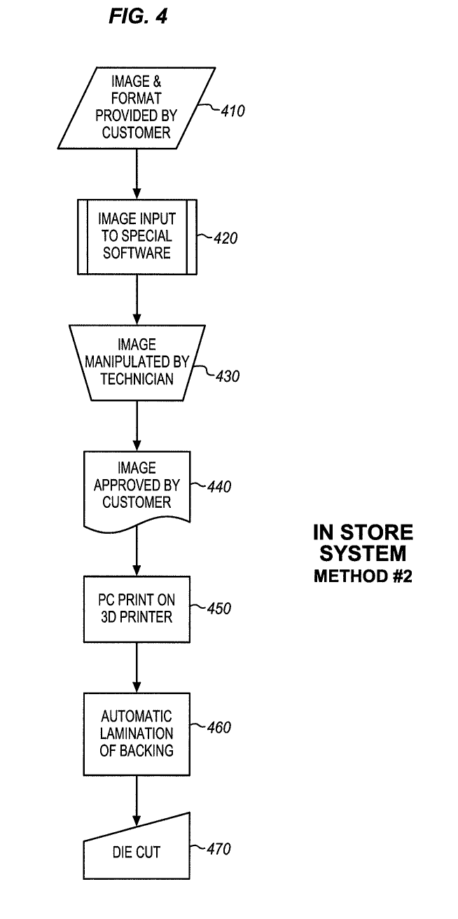

FIG. 4 shows a second in-store method for creating customized images. First, an image and format are provided by a customer in step 410. As discussed above, alternatively, stock images may be used as well. In step 420, the image is inputted to image processing software that will prepare the image for multi-dimensional rendering. In step 430 the image is manipulated by a technician to align the multi-dimensional aspects of the new image. Alternatively, this may be performed by the customer. A special program may be provided or the system may run through a web interface or other interface. In step 440 the image is approved by the customer. The special software will provide a rendering of the multidimensional view that is provided. In step 450 the image is printed on a 3D printer that provides for the formation of lenticular lenses. In step 460 the image is automatically laminated. In step 470 the image is die cut for application.

While we have explained this system for an in store application, the same system can be used by specialty manufacturer's for more complex products such as molded in electronic decorative cases. The individual and the company could correspond over the internet and have the part sent out in hours for overnight delivery.

A product can be customized on demand. A case or skin can be produced as a one off product in a short time period. There are two ways of doing this:
Have a digital press at the injection molding shop producing the finished case; or
Have an in store system to produce the case within a short time at the store.

The manufacturing site could also have a laminator to produce one off skins that would slip into a pre-made case. This would allow the customer to change the theme of the case simply by changing the image card.

The design of the case for the decorative product will determine the method of manufacture and the replacement product that can be obtained on demand. Following are several cases which can be used as decorative cases. Some of these cases are included as the system to decorate follows the system outline within this patent. However, due to the nature of the finished product they are manufactured initially in one location.

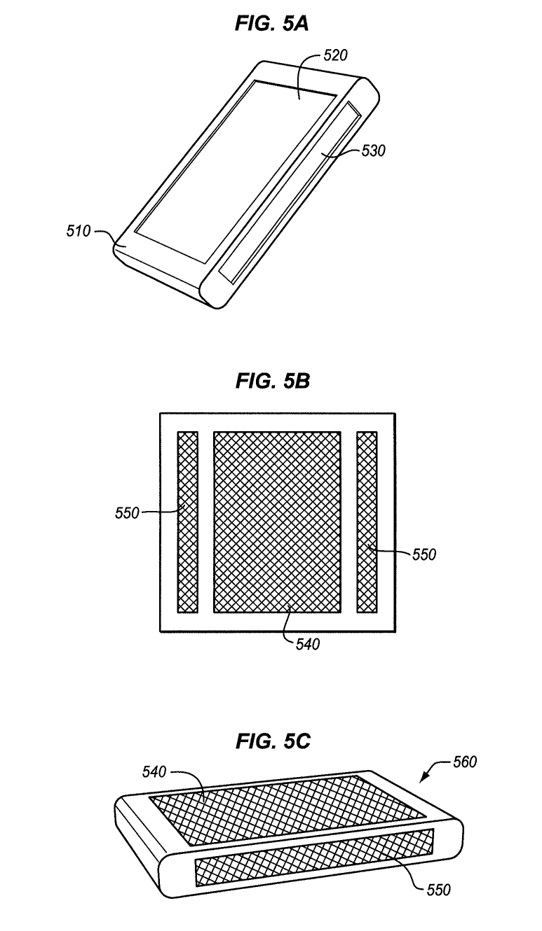

FIGS. 5a-c show an embodiment of a case and multidimensional image system. This may be referred to as an indent case with stick-on imagery. The case 510 includes a plurality of recesses 520, 530 in different locations on the case 510. These positions are merely exemplary and may vary in alternative systems. These recesses are designed and sized to receive multidimensional images that include an adhesive back. Images 540, 550 are placed in the corresponding recesses and the complete case with multidimensional images 560 is assembled. The recesses 520, 530 may be designed to precisely match the thickness of the images, thereby producing a flush or flat surface upon insertion. Case 510 is molded to fit the dimensions of the electronic device. An indentation is designed into the case wherever a multi-dimensional image is to be applied. The imagery is a finished printed piece with adhesive applied to the back side. The piece is provided as a die cut piece that will fit into the molded indentations. The imagery is peeled from the release paper and applied directly to the case. If the adhesive is formulated such that the decorative imagery can be peeled off then new imagery can be applied to the case as so desired by the owner. Alternately, an adhesive can be formulated so a permanent bond is formed between the case and decorative imagery. In this instance the imagery can be applied at the manufacture site. This technique is preferred in initial stages due to exclusivity of the case. Similarly, by using this process the base material for the case can be varied from very flexible materials to rigid materials. The advantage of this case is that the imagery and case is smooth and easy to handle.

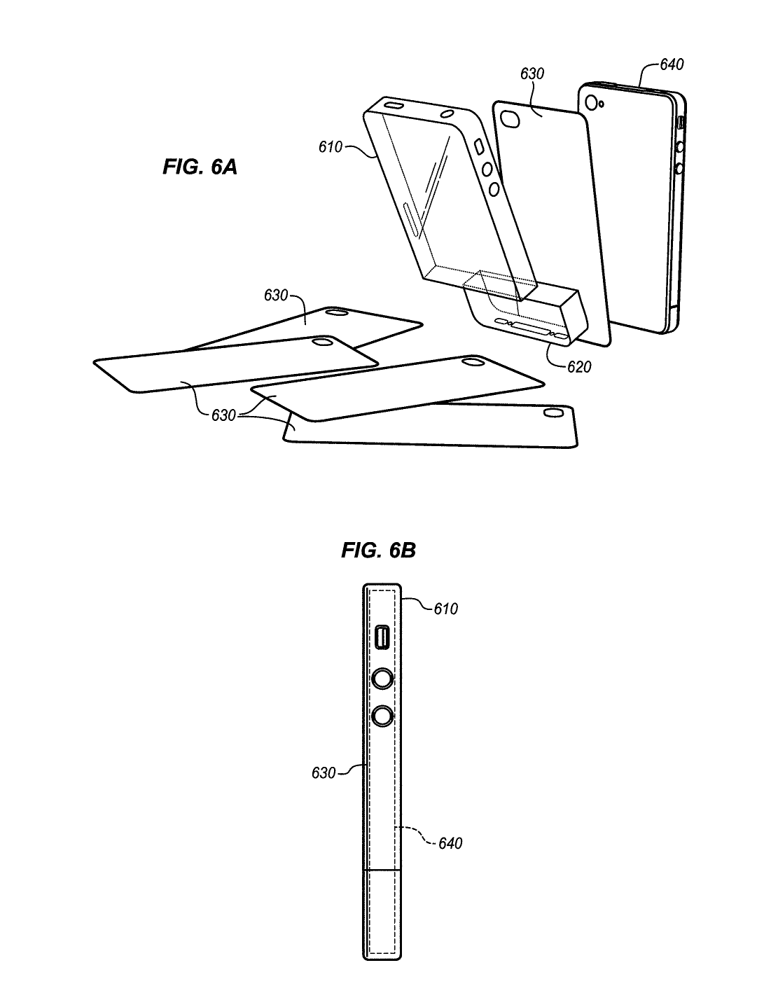

FIG. 6a and b show another embodiment of a case and multidimensional image system. This embodiment may be referred to as a two part molded case. In this embodiment the recess for the image 630 is located on the interior of the case made up of sub-pieces 610, 620. This case is sized for an iPhone or similar type device 640. Similarly, the image may include adhesive or may be snap or press fit, relying on more precise sizing. In this embodiment the lenticular lenses that provide for multi-dimensional viewing may be part of the image or may be part of the case itself. In the instance where the lenticular lenses are part of the case, modification of which portions appear in which dimensional view is limited, however since unlimited customization of images may not be desirable for consumer systems, this may not be a major drawback. Greater flexibility in the three dimensional make up of the image may be obtained if the image portion includes the lenticular lenses; however, care with adhesive may be necessary as to not disrupt the lenticular lenses. This case 610, 620 is molded so two pieces fit over the electronic device. The design is developed so there is sufficient room between the device and the case to insert the printed imagery.

In some embodiments, no adhesive is applied and the imagery can be readily replaced. The disadvantage is that this is a one two piece molded part as opposed to a single piece in the other designs.

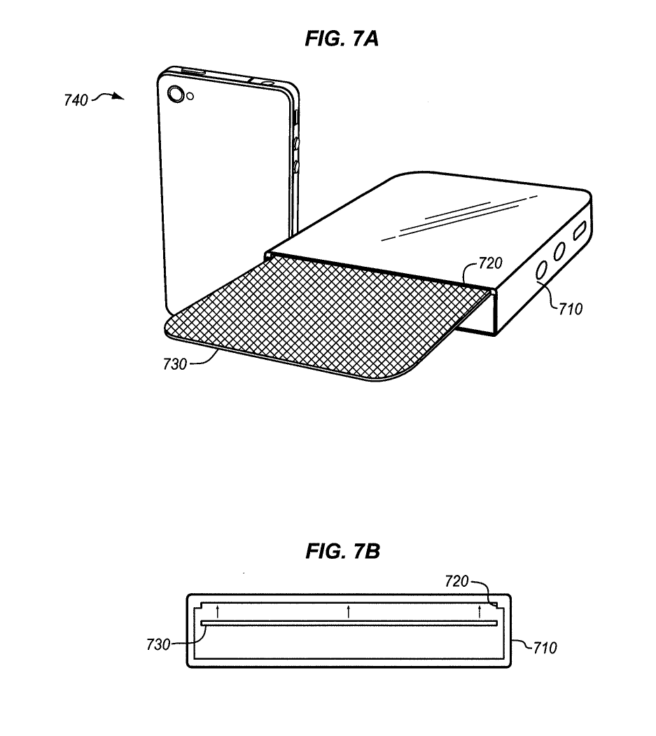

FIGS. 7a-b show another embodiment of a case and multidimensional image system. This embodiment may be referred to as a molded insert case. In this embodiment, a slot 720 in case 710 is utilized to receive image 730, yielding completed case 740. Slot 720 and image 730 may be precisely sized as to create a frictional retention of image 730. A release cut away at the end opposite the insertion end of slot 720 may be included to provide for the release of image 730.

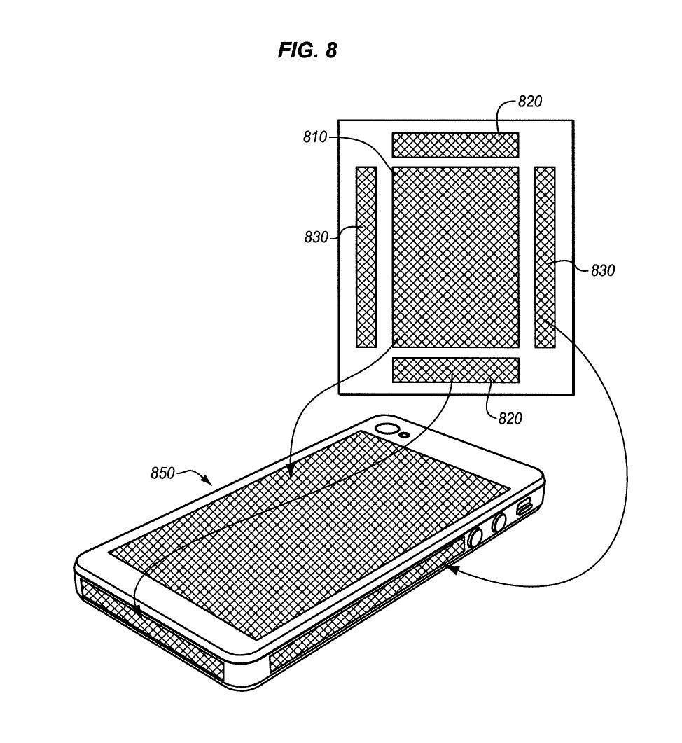

In another embodiment, lenticular images 810, 820, 830 may be applied directly to the surface of the electronic device 850 as shown in FIG. 8. This case may be referred to as a low cost decal system. A multidimensional image is produced and printed on the plastic. The image is adhesively back coated (either direct coated or laminated to adhesive) and finally die cut to the dimensions of the finished electronic device. Various side and top pieces can be included into the decals. The recipient of the decal system peels off the appropriate decals and places the adhesively bonding decal directly onto the electronic wireless device. The adhesive maybe such that it permanently bonds to the device or is a removable adhesive that allows one to peel off the original decal and replace with a second or third decorate decal system. The disadvantage of such a system it provides limited protection to the device.

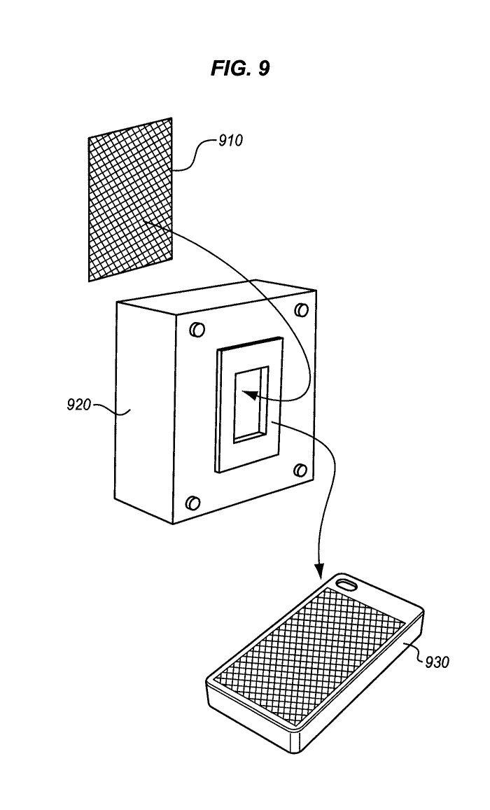

In another embodiment shown in FIG. 9, the image 910, may be placed in an injection mold 920 to be formed as part of the resulting case 930.

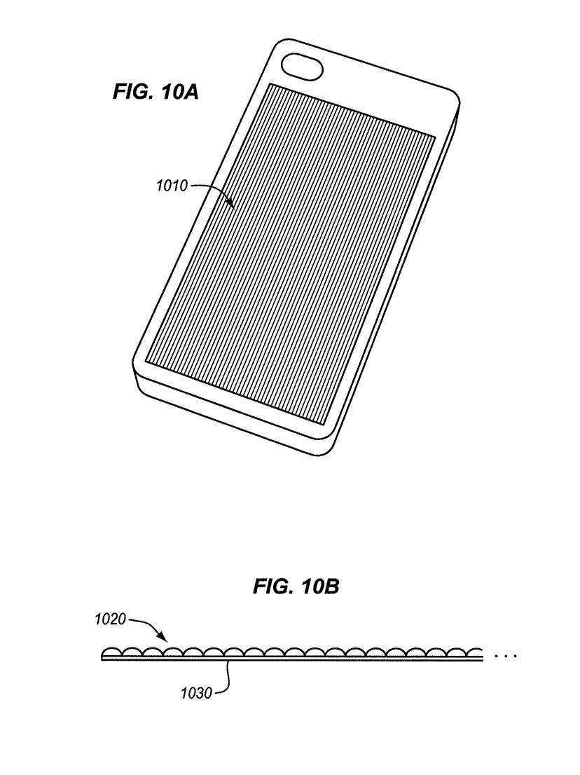

In another embodiment shown in FIGS. 10a and 10b, the image 1030 is infusion printed into the plastic of case 1010. The lenticular lens 1020 is formed and the image 1030 is printed on the back of the case in reverse. The lens structure is formed via a build up process. In one alternative, infusion printing is used to print directly on the back of a case that has been molded with a lenticular lens already in the case. Alternatively, the image may be infusion printed and then the case may be built up over image by printing with a 3D printer including the creation of the lenticular lenses. The case produced by the printer would have the micro lens array in the case. This technique is good for on demand cases having a 3D image printed on the case.

Table #1 was compiled to show which design aspects can be modified with each system.

TABLE #1

| | Central | In Store | On Demand |
|---|---|---|---|
| Case No. | Manufacture | Replacement | Replacement |
| 5 | Y | Y | Y |
| 6 | Y | Y | Y |
| 7 | Y | Y | Y |
| 8 | Y | Y | Y |
| 9 | Y | N | Y |
| 10 | Y | N | Y |

The system may be used to produce to produce decorative products on demand. Several designs for decorative cases for electronic devices may be made. The system may be extended to other products such as:
Personal Consumer 3D Pictures
Greeting Cards
Decorative pictures
Report Covers
Magnets
Business Cards
Gag Gifts
Souvenirs
Etc.

The previous detailed description is of a small number of embodiments for implementing cases with multi-dimensional images and other multi-dimensional image system for electronic devices and is not intended to be limiting in scope. The following claims set forth a number of the embodiments disclosed above with greater particularity.

What is claimed:

1. A system for providing on-demand multidimensional images, comprising:
a computing system, including images manipulation software, the computing system configured to receive an image from a user, process the image using the image manipulation software, the image manipulation software adding at least one different viewing dimension to the image;
a printing system, the printing system in communication with computing system, the printing system configured to print the image including the at least one different viewing dimension.

2. The system of claim 1, wherein the image including the at least one different viewing dimension is configured to be used with an case having an area for receiving the image, the case having a lenticular lens, the configuration of the lenticular lens known by the manipulation software in order to create the at least one different viewing dimension.

3. The system of claim 1, wherein the printing system is a 3D printer.

4. The system of claim 3, wherein the printing system builds up a lenticular lens over the image in order to create the at least one different viewing dimension.

5. The system of claim 1, wherein the printed image is laminated, die cut, and sized to position on an electronic device.

6. A case system for an electronic device, the case system comprising:
a case body, the case body shaped to hold an electronic device;
a multidimensional image located on the case body.

7. The case system of claim 6, wherein the case body includes a recess, the recess having a first thickness, the multidimensional image sized to fit in the recess, the multidimensional image having second thickness, the second thickness approximately equal to the first thickness, such that the multidimensional image in conjunction with the case body forms an approximately flat surface.

8. The case system of claim 7, wherein the recess is on the outer surface of the body.

9. The case system of claim 7, wherein the multidimensional image is laminated on a surface adjacent to the case body.

10. The case system of claim 6, wherein the case body includes a recess on an inner surface of the case body, the recess having a first thickness, the multidimensional image sized to fit in the recess, the multidimensional image having second thickness, the second thickness approximately equal to the first thickness, such that the multidimensional image in conjunction with the case body forms an approximately flat surface.

11. The case system of claim 6, wherein the case body includes a slot, the slot sized to fit the multidimensional image.

12. The case system of claim 6, wherein the multidimensional image includes a lenticular lens.

13. A case system for an electronic device, the case system comprising:
a case body, the case body shaped to hold an electronic device;
a multidimensional image located on the case body, wherein the case body includes a recess on an inner surface of the case body, the recess having a first thickness, the multidimensional image sized to fit in the recess, the multidimensional image having second thickness, the second thickness approximately equal to the first thickness, such that the multidimensional image in conjunction with the case body forms an approximately flat surface, and wherein the case body includes a lenticular lens on the case body on a surface opposite to the inner surface of the case body where the recess is located.

14. A method of creating a customized case, comprising:
receiving an image from a customer at a computing system;
manipulating the image with the computing system to create a multidimensional image;
printing the multidimensional image;
inserting the multidimensional image into a case for an electronic device, the case including a lenticular lens system providing multiple image viewing levels.

15. A method of creating a customized case, comprising:
receiving an image from a customer at a computing system;
manipulating the image with the computing system to create a multidimensional image;
printing the multidimensional image, the multidimensional image including a lenticular lens system providing multiple image viewing levels;
inserting the multidimensional image into a case for an electronic device.

16. A method of creating a customized case, comprising:
receiving an image from a customer at a computing system;
manipulating the image with the computing system to create a multidimensional image;
infusion printing the multidimensional image onto a case for an electronic device.

17. The method of claim 16, wherein the infusion printing is performed on an interior portion of the case, the interior portion of the case opposite an exterior portion, the exterior portion having a lenticular lens.

18. The method of claim 16, wherein after the infusion printing is performed a lenticular lens is built up over the multidimensional image.

19. A method of creating a customized case, comprising:
receiving an image from a customer at a computing system;
manipulating the image with the computing system to create a multidimensional image;
placing the multidimensional image in an injection mold;
injection molding a case around the multidimensional image.
